(19) United States
(12) Patent Application Publication
(10) Pub. No.: US 2026/0253261 A1
(43) Pub. Date: Aug. 27, 2026

(54) OBJECTS’ REGIONS FOR PROXIMITY TRIGGERS IN EXTENDED REALITY SCENE DESCRIPTION

(71) Applicant: InterDigital CE Patent Holdings, SAS, Paris (FR)

(72) Inventors: Joao Pedro COVA REGATEIRO, Chateaubourg (FR); Quentin AVRIL, Betton (FR); Patrice HIRTZLIN, Betton (FR); Philippe GUILLOTEL, Vern-sur-Seiche (FR)

(21) Appl. No.: 19/163,672

(22) PCT Filed: Feb. 20, 2024
(86) PCT No.: PCT/EP2024/054312

§ 371 Date: Sep. 9, 2025

(30) Foreign Application Priority Data
Mar. 10, 2023 (EP) 23305324.8

(51) Int. Cl. G06T 9/20; G06T 19/00

(52) U.S. Cl. CPC G06T 9/20; G06T 19/00; G06T 2210/21; G06T 2210/61

(57) ABSTRACT

Methods, devices and data stream are provided to generate, transmit and decode scene descriptions of extended reality scenes. According to the present principles, the scene description graph links nodes and comprises information indicating how proximity triggers have to be evaluated to trigger actions on virtual objects. The conditions on proximity are based on a set of geometrical primitives plus a boundary value that changes the concerned 3D regions.

### 1. TECHNICAL FIELD

The present principles generally relate to the domain of extended reality scene description and extended reality scene rendering. In particular, the present principles relate to the description of proximity triggering between regions of objects in the scene description. The present document is also understood in the context of the formatting and the playing of extended reality applications when rendered on end-user devices such as mobile devices or Head-Mounted Displays (HMD) like see-through glasses.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way that is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking nodes describing virtual objects and actions on these virtual objects on one hand, and binary representations of the virtual content on the other hand. Binary representation of real objects may also be comprised in nodes of the scene description. Such representations of real object may have been obtained, for example by scanning the real environment. Scene description frameworks ensure that the timed media and the corresponding relevant virtual content are available at any time during the rendering of the application. Scene descriptions can also carry data at scene level describing of how the scene objects behave and interact at runtime for immersive XR experiences. Some actions on virtual objects are triggered by proximity triggers. The generic description of the triggering of proximity triggers is a technical challenge as they are involved in a wide range of interactions between virtual object, for example, objects controlled by a human user.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method for encoding an extended reality (XR) scene description in a data stream. The method comprises obtaining a scene graph linking nodes and belonging to the XR scene description, a node describing an object of the an extended reality (XR) scene and comprising triggers. Then, for every node of the scene graph comprising a trigger that is a collision or a proximity trigger, a description of at least a primitive is added to the trigger. A primitive comprises a type of primitive, a description of a 3D region responsive to the type of primitive, and a boundary value indicating an extent of the 3D region. The modified XR scene description is encoded in the data stream. According to the present principles, the primitive belongs to a group of at least two primitives comprising sphere, box, round-box, box frame, torus, capped torus, link, infinite cylinder, capped cylinder, rounded cylinder, cone, infinite cone, capped cone, rounded cone, plane, hexagonal prism, triangular prism, capsule, line, solid angle, cut sphere, cut hollow sphere, ellipsoid, rhombus, octahedron, pyramid, triangle, and quad.

The present principles relate to a device comprising a processor and a memory associated with the processor that is configured to implement the method above.

The present principles relate to a method for rendering an extended reality (XR) scene. The method comprises obtaining a scene graph linking nodes and belonging to a scene description. A node describes an object of the XR scene and is associated with triggers. A trigger, when it is a collision trigger or a proximity trigger, comprises a description of at least a primitive that comprises a type of primitive, a description of a 3D region responsive to the type of primitive and a boundary value indicating an extent of the 3D region. The at least a trigger is activated when a virtual object enters in a region of the XR scene at the extent of the 3D region. At least an action is associated with the at least a trigger. The at least an action is performed when the at least a trigger is activated. The actions belong to a non-exhaustive group of actions comprising haptic feedback, physics simulation, and audio feedback.

The present principles relate to a device comprising a processor and a memory associated with the processor that is configured to implement the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 shows an example graph of an extended reality scene description according to the present principles;

FIG. 2 illustrates an example of a human user interaction with a virtual object through a mechanical device at the renderer side, that is when the XR experience is running;

FIG. 3 shows an example architecture of an XR processing engine which may be configured to implement a method described in relation with the present principles;

FIG. 4 shows an example of an embodiment of the syntax of a data stream encoding an extended reality scene description according to the present principles;

FIG. 5 illustrates a triggering of a proximity trigger based on a sphere volume;

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

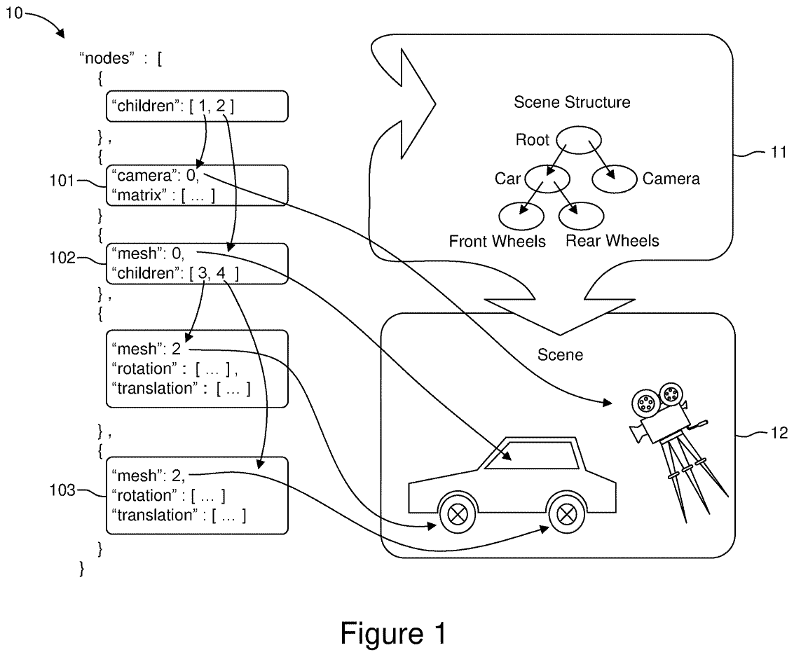

FIG. 1 shows an example scene graph 10 of an extended reality scene description. In this example, the scene graph may comprise descriptions of real objects, for example ‘plane horizontal surface’ (that can be a table or a road) and descriptions of virtual objects 12, for example an animation of a car. The scene graph is organized as an array 10 of nodes. A node can be linked to child nodes to form a scene structure 11. A node can carry a description of a real object (e.g. a semantic description) or a description of a virtual object. In the example of FIG. 1, node 101 describes a virtual camera located in the 3D volume of the XR application. Node 102 described a virtual car and comprises an index of a representation of the car, for example an index in an array of 3D meshes. This representation may have been obtained, for example, by a scanning of the real environment or, for example, may be a model generated by a content creator. This representation corresponds to the object described in this node, and, so, is localized in the 3D scene.

The scene description may comprise numerous arrays comprising descriptions of various aspects of the scene, for example an array containing instructions for several animations, an array containing meshes of several virtual or real objects or an array comprising material descriptions. It also may comprise a description of actions to apply to virtual objects when an event occurs to these objects when playing the XR application, for example when an object controlled by a human user touches a virtual object to push it or to grab it, more generally when virtual objects collide or approaches other virtual objects or boundaries of the scene. Node 103 is a child of node 102 and comprises a description of one wheel of the car. The same way, it comprises an index to the 3D mesh of the wheel. The same 3D mesh may be used for several objects in the 3D scene as the scale, location and orientation of objects are described in the scene nodes. In the example of FIG. 1, the same mesh may be used for the four wheels of the virtual car. Scene graph 10 also comprises nodes that are a description of the spatial relation between the virtual objects.

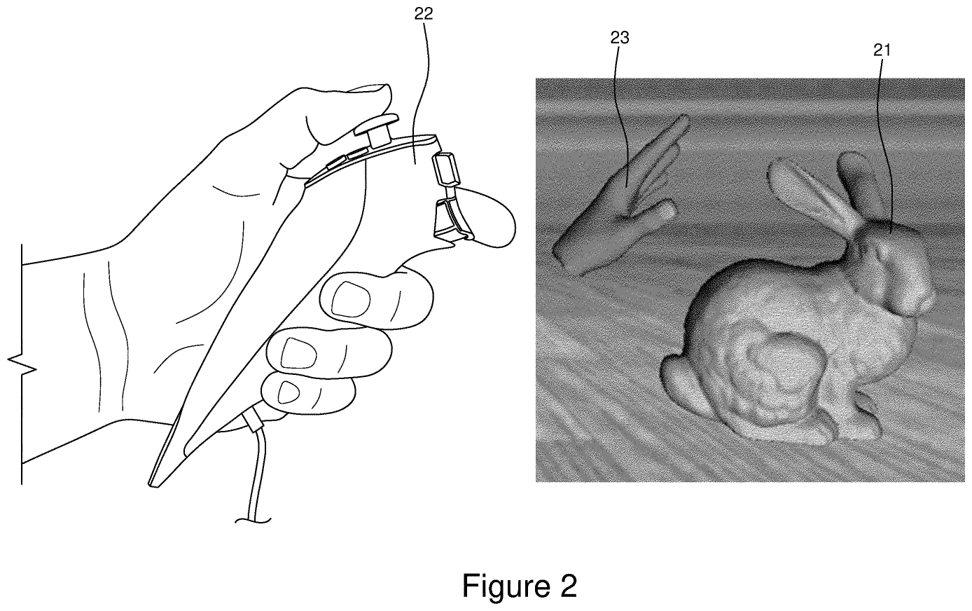

Digital human representation is an active area of research and have initially been proposed for visualization and replay of video content. In the recent years, research has been driven to animated and manipulate digital human representations. This can be performed through skeletal skinning techniques or learning-based methods. With the exploitation of virtual environments and advancement in animation technologies the human-to-machine interaction become more natural and intuitive. FIG. 2 illustrates an example of a human user interaction with a virtual object 21 through a mechanical device 22 at the renderer side, that is when the XR experience is running. This interaction is activated (i.e. associated actions are triggered) when virtual object 23 controlled by the user approaches an area of interest containing virtual object 21. The triggered actions realize different functionalities, like grasping, haptics feedback, sound effects or collision detection for object manipulation. Other types of triggers may co-exist in the scene description, for example triggers based on a timer or triggers based on a combination of actions by a user. The renderer obtains a scene description generated according to the present principles. When a trigger is activated, the associated actions are performed.

FIG. 5 illustrates a triggering of a proximity trigger based on a sphere volume. Proximity triggers based on a sphere volume are easy to compute but limited in practice. Indeed, virtual objects may have different areas of interest with different geometrical representation that consequently affects the user interactions. A sphere volume of virtual object 21 of FIG. 2 is described by the 3D coordinates of a center 51 and a radius 52. This description defines an outer bounding sphere 53. When the sphere volume of virtual object, for example object 23 of FIG. 2, initially at a position 54, intersects the outer bounding sphere 53 at a position 55, the associated proximity trigger is activated, and corresponding actions are applied to both objects. The use of this only primitive is limited when dealing with articulated bodies and limited when using simple objects such as bunny character 21 of FIG. 2.

According to the present principles, additional geometric primitives are anchored to virtual objects and/or to parts of virtual objects. These additional primitives constitute valuable information to facilitate rendering engines to generate accurate interaction between virtual objects. These primitives allow to exploit scenarios of social behaviors, time-based animations and privacy issues that is a common event in the real-world and world of social technologies. According to the present principles, geometrical primitives are defined and are added to the triggers of nodes of the scene graph that describe virtual objects (even the root node encompassing the entire scene) with the intent to activate triggers (e.g. collision or proximity triggers for which actions are performed when two primitives intersect, and this action can represent any activity, such as, collision, proximity, social behavior, privacy, abilities/capabilities, sound, haptics, etc).

According to the present principles, a representation of an interactivity space of a virtual object with new primitives is intended to be compatible with existing scene description formats. Herein, the format proposed according to the present principles follows the glTF format and is compatible with the current MPEG effort to extend glTF with MPEG extensions. However, the meaning and use is generic and can be coded with any other formats (e.g. XML, USD, . . . ).

Encompassing volumes may be from different natures. According to the present principles, there are at least two primitives defining volumes which may different roles. A primitive is defined by a type of primitive (eg. Box (=cube in 3D), Square (in 2D), Cylinder, Capsule, Sphere (in 3D), or Signed distance field). A primitive is also defined by a set of parameters that depends on the primitive type. The values, and so, the default values, of parameters of a primitive depends on the type of the primitive and on the virtual object the proximity primitive is applied. For example:

| | |
|---|---|
| Box | Primitive that represents a 3D cubical and is defined by 3D coordinates |
| | of a center and 3 parameters (width, height, depth), plus an optional |
| | parameter that represent an orientation, for example the orientation of |
| | height. In a variant, the box is a cube and only one of the 3 values is |
| | transmitted. In a variant every parameter represent the half of the size |
| | of the cubical like a radius represents the half of the diameter of a |
| | sphere. |
| Square | Primitive that represents a 2D square and is defined by width and height |
| | and 2D coordinates of a center. |
| Cylinder | Primitive that represents a 3D cylinder and is defined by a radius, a |
| | length and 3D coordinates of a center. Other representations are |
| | possible. |
| Capsule | Primitive that represents a 3D capsule and is defined by a radius, and |
| | two 3D coordinates of a anchors, base and top represented with 3D |
| | coordinates. |
| Sphere | Primitive that represents a 3D sphere and is defined by a radius and 3D |
| | coordinates of a center. |
| Signed | Primitive that represents a 3D volume of any 3D geometric |
| distance | representation. It is described as a function that takes as input 3D |
| field | coordinates and that returns the distance from the input to the nearest |
| | surface. Such a function may be used to represent any of the previous |
| | primitives. The function itself may be listed in a standard (that means |
| | know a priori) or can be transmitted as a parametric function through, |
| | for instance, as a type (eg. quadratic polynomial or cubical polynomial, |
| | or Bezier functions) and a set of parameters (eg. 3 real numbers for a |
| | quadratic, four ones for a cubical). |

This list of possible primitives is not exhaustive.

A primitive is a geometrical item that defines a region of the 3D space of the XR scene that surrounds a given virtual object (or apart of a virtual object). Different types of regions are possible according to the actions or behaviors that the proximity trigger they are associated with are linked to. For example, a “social region” corresponds to a given social distance of any object from this given object. It can be generic (for instance, a default distance can be set to 1 m or 4 feet), or it can be user defined. At the renderer side, when interacting with another object, if an intersection of the region of a first object with the region of the given object is detected, the trigger is activated. So, there is a difference between the region defined by the primitive and the region that triggers the proximity actions. In other words, there is a distance value (called boundary) described in the parameters of the related trigger of the scene description indicating at what distance from a centroid of the primitive the trigger is activated, that is when this social region becomes active. A “contact region” is a direct collision detection trigger. For this kind of region, the boundary is set to zero. That means the proximity trigger is activated when a first primitive intersects the given primitive. Such regions may trigger haptic feedback, physics simulation, audio feedback or any other event. It can also affect an avatar's attributes, if necessary, when two contact regions overlap, such as, a “vital space” of an avatar intersect a social event “vital space”, which triggers an action for sports activity, enabling all users/objects to perform actions that were once not possible, such as flying, jumping, speech. A “legal region” may be used, for example, in a scenario of legal permissions. The allowed displacement of a virtual object may be limited for legal reasons (age, restrictions, access rights etc.). Such a region would represent the limited space this avatar is allowed to move in. An “experience region” corresponds to the space the object is allowed to move in considering obstacles and corresponding to the generated space. In a related way, a “parental region” may be set to protect children and young adults to limit the interaction with allowed content. For every kind of region, a default boundary value may be defined or set in a table associated with the scene description.

To illustrate a possible syntax of the primitives for proximity triggers in a scene description, an extension of the glTF node “MPEG_node_interactivity” elements is proposed below. Since the MPEG interactivity glTF extension allows triggers in the situation of collision and proximity, the proposed extension contributes with an extension of new primitives description for the proximity trigger in the node “MPEG_node_interactivity”. The generic node implementation can also be applied to the avatar representation, to add interactivity constraints on the avatar and respective elements.

The glTF node element “MPEG_node_interactivity” properties are extended to define additional geometric primitives for the “TRIGGER_PROXIMITY” to delimit regions of interactivity. This element extension describes additional base primitives for a node characterized as elements of interactivity. This element provides additional information to client applications about the areas of interaction between the scene and objects within. This can be applied, for instance, as boxes, cylinders, spheres or distance functions objects. For example, the surrounding region of an avatar can be defined as a cuboid area for triggers activity, for instance for only allowing interactive objects trigger actions which consequently impact the avatar. Node body elements of an avatar can be individually set with different primitives to interact with scene objects within this primitive bounding region e.g., avatars can use the arms to grab or grasp objects.

Some definitions have to be set for any scene description.

For MPEG_node_interactivity_primitive extension description:

| Name | Type | Usage | Default | Description |
|---|---|---|---|---|
| primitive | array | Optional | [ ] | List of primitives used to |
| | | | | activate the proximity trigger. |

The semantic description or the primitive property:

| Name | Type | Usage | Default | Description |
|---|---|---|---|---|
| type | string | O | “sphere” | Describes the type of primitive |
| | | | | used to activate the proximity |
| | | | | trigger. The available options |
| | | | | are. “box”, “square”, |
| | | | | “cylinder”, “capsule”, “SDF” |
| | | | | and the default “sphere”. |
| bound- | number | O | 0.0 | Defines the region of |
| ary | | | | intersection within the |
| | | | | primitive. if zero then all area |
| | | | | of the primitive activates the |
| | | | | trigger. |

Semantics of the type of primitives:

| | | | |
|---|---|---|---|
| box-region | object | O | Box representation for the |
| | | | region of trigger activity. |
| square-region | object | O | Square representation for the |
| | | | region of trigger activity. |
| cylinder-region | object | O | Cylinder representation for the |
| | | | region of trigger activity. |
| capsule-region | object | O | Capsule representation for the |
| | | | region of trigger activity. |
| sphere-region | object | O | Sphere representation for the |
| | | | region of trigger activity. |
| SDF-region | object | O | Signed distance field that can |
| | | | take the shape of more complex |
| | | | primitives. |

The semantics of each individual region is provided in the following table where ‘M’ stands for ‘Mandatory’:

| Name | Type | Usage | Default | Description |
|---|---|---|---|---|
| If(type == “box- | | | | |
| region”){ | | | | |
| width | number | M | 1.0 | Width of the bounding box. |
| height | number | M | 1.0 | Height of the bounding box. |
| depth | number | M | 1.0 | Depth of the bounding box. |
| centroid | array | M | [0.0, 0.0, 0.0] | Centre 3D coordinate (x,y,z) |
| | | | | of the cube |
| } | | | | |
| If (type == “square- | | | | |
| region”){ | | | | |
| width | number | M | 1.0 | Width of the bounding |
| | | | | square. |
| height | number | M | 1.0 | Height of the bounding |
| | | | | square. |
| centroid | array | M | [0.0, 0.0] | Centre 2D coordinate (x,y) |
| | | | | or (x,z) or (y,z) of the square. |
| } | | | | |
| If (type == “cylinder - | | | | |
| region”){ | | | | |
| radius | number | M | 1.0 | Radius of the bounding |
| | | | | cylinder. |
| length | number | M | 1.0 | Length of the bounding |
| | | | | cylinder. |
| centroid | array | M | [0.0, 0.0, 0.0] | Centre 3D coordinate (x,y,z) |
| | | | | of the cylinder |
| } | | | | |
| If (type == “capsule - | | | | |
| region”){ | | | | |
| radius | number | M | 1.0 | Radius of the bounding |
| | | | | capsule. |
| base | array | M | [0.0, 0.0, 0.0] | Centre 3D coordinate (x,y,z) |
| | | | | of the base semi-sphere of |
| | | | | the capsule. |
| top | array | M | [0.0, 0.0, 0.0] | Centre 3D coordinate (x,y,z) |
| | | | | of the top semi-sphere of the |
| | | | | capsule. |
| } | | | | |
| If (type == “sphere - | | | | |
| region”){ | | | | |
| radius | number | M | 1.0 | Radius of the bounding |
| | | | | sphere. |
| centroid | array | M | [0.0, 0.0, 0.0] | Centre 3D coordinate (x,y,z) |
| | | | | of the sphere. |
| } | | | | |

Semantical description of each primitive available with SDF:

| | |
|---|---|
| SDF-region | Sphere, Box, Round-box, Box Frame, Torus, Capped Torus, Link, |
| List of | Infinite Cylinder, Arbitrary Capped Cylinder, Rounded Cylinder, Cone, |
| possible | Infinite Cone, Capped Cone, Rounded Cone, Plane, Hexagonal Prism, |
| primitives | Triangular Prism, Capsule, Line, Solid Angle, Cut Sphere, Cut Hollow |
| | Sphere, Ellipsoid, Rhombus, Octahedron, Pyramid, Triangle, Quad, |
| | Any volumetric shape. |

The following glTF is an example (not exhaustive) of an instantiation of a “MPEG_node_interactivity_primitives” in clients that supports “MPEG_node_interactivity”, and otherwise fall back to a standard ‘MPEG_node_interactivity’.

### Example of “MPEG_Node_Interactivity” Properties Extension

```
“nodes”: [
  {
    “extensions”: {
      “MPEG_node_interactivity”: {
        “type” : “TRIGGER_PROXIMITY”,
        “nodes”: [4, 5],
            “type”: “box”,
            “boundary”: 0.0,
            “box_region”: {
              “dimensions”: {
                “width”: 1.0,
                “height”: 1.0,
                “depth”: 1.0
                },
              “centroid”: [
                0.0,
                0.0,
                0.0
              ]
              }
        }
      }
    }
  }
]
```

### Examples of Extension of the “MPEG_Node_Interactivity” Extensions Property

```
“nodes”: [
  {
    “extensions”: {
      “MPEG_node_interactivity”: {
        “type” : “TRIGGER_PROXIMITY”,
        “nodes”: [1, 2, 3],
        “extensions”: {
          “MPEG node_interactivity_primitives” :{
            “type”: “square”,
            “boundary”: 0.5,
            “square_region”: {
              “dimensions”: {
                “width”: 1.0,
                “height”: 1.0
                },
              “centroid”: [
                0.0,
                0.0
              ]
              }
            }
          }
        }
      }
    }
  }
]
```

```
“nodes”: [
  {
    “extensions”:{
      “MPEG_node_interactivity”: {
        “type” : “TRIGGER_PROXIMITY“.
        “nodes”: [1, 2, 3],
        “extensions”: {
          “MPEG_node_interactivity_primitives” : {
          “type”: “cylinder”,
          “boundary”: 0.0,
          “cylinder_region”:
            “dimensions”: {
              “radius”: 1.0,
              “length”: 5.0
              }
              “centroid”: [
                0.0,
                0.0,
                0.0
              ]
              }
            }
          }
        }
      }
    }
  }
]
```

```
“nodes”: [
  {
    “extensions”: {
      “MPEG_node_interactivity”: {
        “type” : “TRIGGER_PROXIMITY”,
        “nodes”: [1, 2, 3],
        “extensions”: {
          “MPEG_node_interactivity_primitives” : {
            “type”: “capsule”,
            “boundary”: 0.0,
            “capsule_region”: {
              “dimensions”: {
                “radius”: 1.0 },
              “base”: [
                0.0,
                0.0,
                0.0
              ],
              “top”: [
                1.0,
                1.0,
                1.0
              ]
              }
            }
          }
        }
      }
    }
  }
]
```

```
“nodes”: [
  {
    “extensions”: {
      “MPEG_node_interactivity”: {
        “type” : “TRIGGER_PROXIMITY”,
        “nodes”: [1, 2, 3],
        “extensions”: {
          “MPEG_node_interactivity_primitives” : {
            “type”: “sphere”,
            “boundary”: 0.5,
            “sphere_region”: {
              “dimensions”: {
                “radius”: 1.0 },
              “centroid”: [
                0.0,
                0.0,
                0.0
              ]
              }
            }
          }
        }
      }
    }
  }
]
```

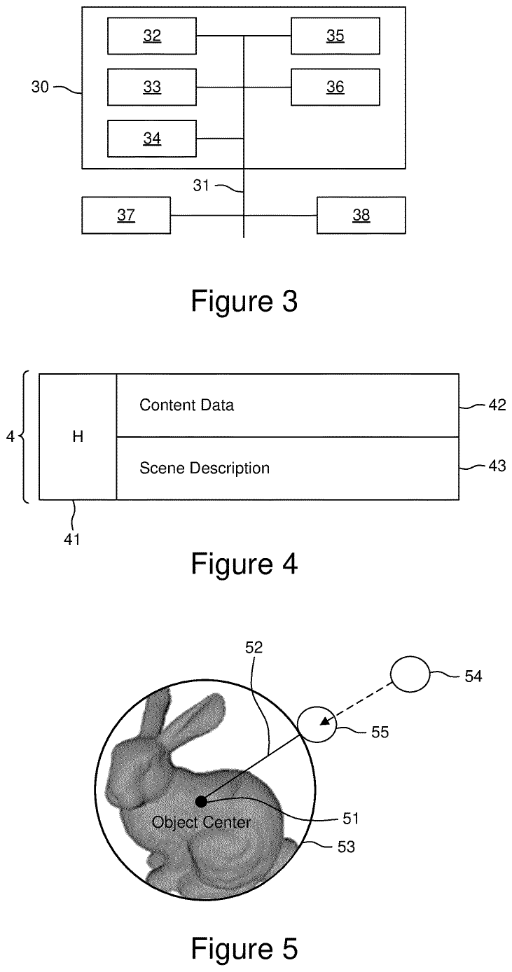

FIG. 3 shows an example architecture of an XR processing engine 30 which may be configured to implement the present principles. A device according to the architecture of FIG. 2 is linked with other devices via their bus 31 and/or via I/O interface 36.

Device 30 comprises following elements that are linked together by a data and address bus 31:D
a processor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 2), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device.

Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method according to the present principles, and belongs to a set comprising:
a mobile device;
a communication device;
a game device;
a tablet (or tablet computer);
a laptop;
a still picture camera;
a video camera.

FIG. 4 shows an example of an embodiment of the syntax of a data stream encoding an extended reality scene description according to the present principles. FIG. 3 shows an example structure 4 of an XR scene description. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure also comprises a payload comprising an element of syntax 42 and an element of syntax 43. Syntax element 42 comprises data representative of the media content items describes in the nodes of the scene graph related to virtual elements. Images, meshes and other raw data may have been compressed according to a compression method. Element of syntax 43 is a part of the payload of the data stream and comprises data encoding the scene description as described according to the present principles.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

### Annex A

glTF Schemas

### Semantics

MPEG_node_interactivity_primitive object

```
    {
      “$schema”: “http://json-schema.org/draft-04/schema”,
      “title”: “MPEG_node_interactivity_primitives extension”,
      “type”: “object”,
      “description”: “MPEG_node_interactivity_primitive is used represent bounding
regions for nodes that use proximity trigger.”,
      “allOf”: [ { “$ref”: “glTFProperty.schema.json” } ],
      “properties”: {
        “primitive”: {
          “type”: “array”,
          “items”: {
            “$ref”: “MPEG_node_interactivity_primitive.objects.schema.json”
          },
          “description”: “List of primitives used to activate the proximity trigger.”
        },
        “extensions”: { },
        “extras”: { }
      },
      “required”: [“primitive“]
    }
```

MPEG_node_interactivity_primitive.objects object

```
    {
      “$schema”: “http://json-schema.org/draft-04/schema”,
      “title”: “MPEG_node_interactivity_primitive.objects extension”,
      “type”: “object”,
      “description”: “MPEG_node_interactivity_primitives is used to interact with other
node in the scene.”,
      “allOf”: [ { “$ref”: “glTFProperty.schema.json” } ],
      “properties”: {
        “type”: {
          “type”: “string”,
          “enum”: [“box”,
            “square”,
            “cylinder”,
            “capsule”,
            “sphere“
          ],
          “description”: “Type of primitive create for this node.”
        },
        “boundary” : {
          “type”: “number”,
          “description”: “Defines the region of intersection within the primitive. if zero
then all area of the primitive activates the trigger.”,
          “default”: 0.0
        },
        “box-region”: {
          “type”: “object”,
          “description”: “Bounding box dimensions and centroid definition.”,
          “items”: {
            “$ref”: “MPEG_node_interactivity_primitives.bb_region.schema.json”
          },
          “minItems”: 1
        },
        “square-region”: {
          “type”: “object”,
          “description”: “Bounding square dimensions and centroid definition.”,
          “items”: {
            “$ref”: “MPEG_node_interactivity_primitives.aabb_region.schema.json”
          },
          “minItems”: 1
        },
        “cylinder-region”: {
          “type”: “object”,
          “description”: “Bounding cylinder dimensions and centroid definition.”,
          “items”: {
                                                                  “$ref”:
“MPEG_node_interactivity_primitives.cylinder_region.schema.json”
          },
          “minItems”: 1
        },
        “capsule-region”: {
          “type”: “object”,
          “description”: “Bounding capsule dimensions and base and top half-spheres
definition.”,
          “items”: {
                                                                  “$ref”:
“MPEG_node_interactivity_primitives.capsule_region.schema.json”
          },
          “minItems”: 1
        },
        “sphere-region”: {
          “type”: “object”,
          “description”: “Bounding sphere dimensions and centroid definition.”,
          “items”: {
            “$ref”: “MPEG_node_interactivity_primitives.sphere_region.schema.json”
          },
          “minItems”: 1
        },
        “extensions”: { },
        “extras”: { }
      },
      “required”: [“type“]
    }
```

MPEG_node_interactivity_primitive.objects.square_region object

```
    {
      “$schema”: “http://json-schema.org/draft-04/schema”,
      “title”: “MPEG_node_interactivity_primitive.objects.square_region object”,
      “type”: “object”,
      “description”: “MPEG node is used to represent a simple 2D geometric primitive.”,
      “allOf”: [ { “$ref”: “glTFProperty.schema.json” } ],
      “properties”: {
        “dimensions”: {
          “allOf”: [
            {“type”: “object”, “properties”: { “width”: {“type”: “number”, “description”:
“Width of the bounding square.”, “default”: 1.0} } },
            {“type”: “object”, “properties”: {“height”: { “type”: “number”, “description”:
“Height of the bounding square.”, “default”: 1.0} } }
          ],
          “description”: “Bounding square dimensions description.”
        },
        “centroid”: {
          “type”: “array”,
          “description”: “The node's 2D position respective of the center in world space
(x, y).”,
          “items”: {
            “type”: “number”
          },
          “minItems”: 2,
          “maxItems”: 2,
          “default”: [ 0.0, 0.0 ]
        },
        “extensions”: { },
        “extras”: { }
      },
      “required”: [ “dimensions”, “centroid”]
    }
```

MPEG_node_interactivity_primitive.objects.box region object

```
    {
      “$schema”: “http://json-schema.org/draft-04/schema”,
      “title”: “MPEG_node_interactivity_primitive.objects.box_region object”,
      “type”: “object”,
      “description”: “MPEG node avatar is used to represent and support avatars.”,
      “allOf”: [ { “$ref”: “glTFProperty.schema.json” } ],
      “properties”: {
        “dimensions”: {
          “allOf”: [
            {“type”: “object”, “properties”: { “width”: {“type”: “number”, “description”:
“Width of the bounding box.”, “default”: 1.0}} },
            {“type”: “object”, “properties”: {“height”: {“type”: “number”, “description”:
“Height of the bounding box.”, “default”: 1.0} } },
            {“type”: “object”, “properties”: { “depth”: { “type”: “number”, “description”:
“Depth of the bounding box.”, “default”: 1.0}} }
          ],
          “description”: “Bounding box dimensions description.”
        },
        “centroid”: {
          “type”: “array”,
          “description”: “The node's 3D position respective of the center in world space
(x, y, z).”,
          “items”: {
            “type”: “number”
          },
          “minItems”: 3,
          “maxItems”: 3,
          “default”: [ 0.0, 0.0, 0.0 ]
        },
        “extensions”: { },
        “extras”: { }
      },
      “required”: [ “dimensions”, “centroid”]
    }
```

MPEG_node_interactivity_primitive.objects.capsule_region object

```
    {
      “$schema”: “http://json-schema.org/draft-04/schema”,
      “title”: “MPEG_node_interactivity_primitive.objects.capsule_region object”,
      “type”: “object”,
      “description”: “MPEG node is used to represent a simple 3D geometric primitive.”,
      “allOf”: [ { “$ref”: “glTFProperty.schema.json” } ],
      “properties”: {
        “dimensions”: {
          “allOf”: [
            {“type”: “object”, “properties”: {“radius”: { “type”: “number”, “description”:
“radius of the capsule.”, “default”: 1.0} } }
          ],
          “description”: “Bounding capsule dimensions description.”
        },
        “base”: {
          “type”: “array”,
          “description”: “The capsule base 3D position respective of the center in world
space (x, y, z).”,
          “items”: {
            “type”: “number”
          },
          “minItems”: 3,
          “maxItems”: 3,
          “default”: [ 0.0, 0.0, 0.0 ]
        },
        “top”: {
          “type”: “array”,
          “description”: “The capsule top 3D position respective of the center in world
space (x, y, z).”,
          “items”: {
            “type”: “number”
          },
          “minItems”: 3,
          “maxItems”: 3,
          “default”: [ 5.0, 5.0, 5.0 ]
        },
        “extensions”: { },
        “extras”: { }
      },
      “required”: [ “dimensions”, “base”, “top”]
    }
```

MPEG_node_interactivity_primitive.objects.cylinder region object

```
    {
      “$schema”: “http://json-schema.org/draft-04/schema”,
      “title”: “MPEG_node_interactivity_primitive.objects.cylinder_region object”,
      “type”: “object”,
      “description”: “MPEG node is used to represent a simple 3D geometric primitive.”,
      “allOf”: [ { “$ref”: “glTFProperty.schema.json” } ],
      “properties”: {
        “dimensions”: {
          “allOf”: [
            {“type”: “object”, “properties”: { “radius”: { “type”: “number”, “description”:
“radius of the cylinder.”, “default”: 1.0} } },
            {“type”: “object”, “properties”: { “length”: { “type”: “number”, “description”:
“Length of the cylinder”, “default”: 1.0}} }
          ],
          “description”: “Bounding cylinder dimensions description.”
        },
        “centroid”: {
          “type”: “array”,
          “description”: “The node's 3D position respective of the center in world space
(x, y, z).”,
          “items”: {
            “type”: “number”
          },
          “minItems”: 3,
          “maxItems”: 3,
          “default”: [ 0.0, 0.0, 0.0 ]
        },
        “extensions”: { },
        “extras”: { }
      },
      “required”: [ “dimensions”, “centroid”]
    }
```

MPEG_node_interactivity_primitive.objects.sphere_region object

```
    {
      “$schema”: “http://json-schema.org/draft-04/schema”,
      “title”: “MPEG_node_interactivity_primitive.objects.sphere_region object”,
      “type”: “object”,
      “description”: “MPEG node is used to represent a simple 3D geometric primitive.”,
      “allOf”: [ { “$ref”: “glTFProperty.schema.json” } ],
      “properties”: {
        “dimensions”: {
          “allOf”: [
            {“type”: “object”, “properties”: {“radius”: { “type”: “number”, “description”:
“radius of the sphere.”, “default”: 1.0} } }
          ],
          “description”: “Bounding sphere dimensions description.”
        },
        “centroid”: {
          “type”: “array”,
          “description”: “The sphere 3D position respective of the center in world space
(x, y, z).”,
          “items”: {
            “type”: “number”
          },
          “minItems”: 3,
          “maxItems”: 3,
          “default”: [ 0.0, 0.0, 0.0 ]
        },
        “extensions”: { },
        “extras”: { }
      },
      “required”: [ “dimensions”, “centroid”]
    }
```

1. A method for encoding an extended reality (XR) scene description in a data stream, the method comprising:
obtaining a scene graph linking nodes and belonging to the XR scene description, wherein a node describes an object of the XR scene and is associated with triggers;
for a node of the scene graph associated with a trigger that is a collision trigger or a proximity trigger, adding a description of at least a primitive to the trigger, wherein a primitive comprises:
a type of primitive;
a description of a 3D region responsive to the type of primitive; and
a boundary value indicating an extent of the 3D region; and
encoding the XR scene description in the data stream.

2. The method of claim 1, wherein a primitive is a geometrical item that defines a region of the XR scene that surrounds a virtual object or a part of a virtual object.

3. The method of claim 1, wherein the boundary value indicates at what distance from a centroid of the at least a primitive the trigger is activated.

4. The method claim 1, wherein a default boundary value is defined for a kind of region associated with the primitive.

5. The method of claim 1, wherein the primitive belongs to a group of at least two primitives comprising sphere, box, round-box, box frame, torus, capped torus, link, infinite cylinder, capped cylinder, rounded cylinder, cone, infinite cone, capped cone, rounded cone, plane, hexagonal prism, triangular prism, capsule, line, solid angle, cut sphere, cut hollow sphere, ellipsoid, rhombus, octahedron, pyramid, triangle, and quad.

6. A method for rendering an extended reality (XR) scene, the method comprising:
obtaining a scene graph linking nodes and belonging to an XR scene description, wherein a node describes an object of the XR scene and is associated with triggers, wherein a trigger that is a collision trigger or a proximity trigger; comprises a description of at least a primitive, and wherein a primitive comprises:
a type of primitive;
a description of a 3D region responsive to the type of primitive; and
a boundary value indicating an extent of the 3D region;
wherein a trigger is activated when a virtual object enters if-a region of the XR scene at the extent of the 3D region; and
wherein at least an action is associated with the trigger, the at least an action being performed when the trigger is activated, the at least an action belonging to a group of actions comprising haptic feedback, physics simulation, and audio feedback.

7. A device for encoding an extended reality (XR) scene description in a data stream comprising a processor and a memory associated with the processor, the processor being configured to:
obtain a scene graph linking nodes and belonging to the XR scene description, wherein a node describes an object of the XR scene and is associated with triggers;
for a node of the scene graph comprising a trigger that is a proximity trigger, add a description of at least a primitive to the node, wherein a primitive comprises:
a type of primitive;
a description of a 3D region responsive to the type of primitive; and
a boundary value indicating an extent of the 3D region; and
encode the XR scene description in the data stream.

8. The device of claim 7, wherein a primitive is a geometrical item that defines a region of the XR scene that surrounds a virtual object or a part of a virtual object.

9. The device of claim 7, wherein the boundary value indicates at what distance from a centroid of the at least a primitive the trigger is activated.

10. The device of claim 7, wherein a default boundary value is defined for a kind of region associated with the primitive.

11. The device of claim 7, wherein the primitive belongs to a group of at least two primitives comprising sphere, box, round-box, box frame, torus, capped torus, link, infinite cylinder, capped cylinder, rounded cylinder, cone, infinite cone, capped cone, rounded cone, plane, hexagonal prism, triangular prism, capsule, line, solid angle, cut sphere, cut hollow sphere, ellipsoid, rhombus, octahedron, pyramid, triangle, and quad.

12. A device for rendering an extended reality (XR) scene, the device comprising a processor and a memory associated with the processor, the processor being configured to:
obtain a scene graph linking nodes and belonging to an XR scene description, wherein a node describes an object of the XR scene and is associated with triggers, wherein a trigger that is a collision trigger or a proximity trigger comprises a description of at least a primitive, and wherein a primitive comprises:
a type of primitive;
a description of a 3D region responsive to the type of primitive; and
a boundary value indicating an extent of the 3D region;
wherein a trigger is activated when a virtual object enters in-a region of the XR scene at the extent of the 3D region; and
wherein at least an action is associated with a trigger, the at least an action being performed when the trigger is activated, the at least an action belonging to a group of actions comprising haptic feedback, physics simulation, and audio feedback.
